(19) United States
(12) Patent Application Publication
(10) Pub. No.: US 2012/0155352 A1
(43) Pub. Date: Jun. 21, 2012

(54) WIRELESS LOCAL AREA COMMUNICATION SYSTEM

(75) Inventors: Hoon JEONG, Daejeon (KR); Nae Soo Kim, Daejeon (KR)

(73) Assignee: Electronics and Telecommunications Research Institute, Daejeon (KR)

(21) Appl. No.: 13/324,301

(22) Filed: Dec. 13, 2011

(30) Foreign Application Priority Data
Dec. 15, 2010 (KR) 10-2010-0128354

(51) Int. Cl. H04W 84/02; H04W 52/02

(52) U.S. Cl. 370/311

(57) ABSTRACT

Provided is a method of classifying and thereby providing various types of communication devices in a wireless local area communication network. More particularly, provided is a method that may provide an end device for efficient data communication. A parent device of an end device not supporting a sleep mode may transfer data without waiting for a polling operation of the end device.

### CROSS-REFERENCE TO RELATED APPLICATION

This application claims the priority benefit of Korean Patent Application No. 10-2010-0128354, filed on Dec. 15, 2010, in the Korean Intellectual Property Office, the disclosure of which is incorporated herein by reference.

### BACKGROUND

1. Field of the Invention

Embodiments of the present invention relate to technology for providing various types of communication devices for a wireless local area communication network, and more particularly, to a wireless local area communication system that may provide an end device for efficient data communication.

2. Description of the Related Art

A wireless local area communication network may include a plurality of communication devices and provide a data communication function. Such communication devices may be defined based on a standard, for example, a ZigBee standard and an Institute of Electrical and Electronics Engineers (IEEE) 802.15.4 standard.

For example, in the ZigBee standard, communication devices may be classified as a personal area network (PAN) coordinator, a router, and an end device. In the IEEE 802.15.4 standard, communication devices may be classified as a full function device (FFD) and a reduced function device (RFD). Here, the PAN coordinator and the router of the ZigBee standard may correspond to the FFD of the IEEE 802.15.4 standard. The end device of the ZigBee standard may correspond to the RFD of the IEEE 802.15.4 standard.

The conventional end device may communicate only with a parent device transferring data to the end device. In particular, even though the end device may directly transfer data to the parent device, the end device may receive data from the parent device through periodical polling when the end device is to receive data from the parent device.

Specifically, the PAN coordinator or the router may wait for the periodical polling of the end device corresponding to a child device of the PAN coordinator or the router and then transfer data to the end device. When a polling duration is extended, transmission of data including the corresponding end device may be delayed compared to other transmission.

### SUMMARY

An aspect of the present invention provides a wireless local area communication system that may separately provide an end device supporting a sleep mode and an end device not supporting the sleep mode in an Institute of Electrical and Electronics Engineers (IEEE) based ZigBee network that operates in a non-beacon enable mode.

According to an aspect of the present invention, there is provided a wireless local area communication system, including: a personal area network (PAN) coordinator to generate a single wireless communication network, having a PAN identifier (ID), in a single coverage area; a router to perform a routing function associated with the PAN coordinator in interoperation with the PAN coordinator; and at least one end device to perform a data communication with the PAN coordinator or the router when the at least one end device enters the coverage area. The at least one end device may be classified as a first end device to periodically switch on or off a reception module for the data communication by performing a sleep mode, and as a second end device to maintain an on-state of the reception module without performing the sleep mode.

When the at least one end device enters the coverage area, the at least one end device may operate as one of the first end device and the second end device based on a profile or a selection input of a user.

The wireless local area communication system may provide a wireless communication according to a ZigBee communication standard or an Institute of Electrical and Electronics Engineers (IEEE) communication standard.

According to another aspect of the present invention, there is provided an operation method of an end device in a wireless local area communication system, the method including: selecting one operation mode from an operation mode of a first end device and an operation mode of a second end device, the first end device periodically switching on or off a reception module for a data communication by performing a sleep mode based on a profile or a selection input of a user, and the second end device maintaining an on-state of the reception module without performing the sleep mode; and controlling the reception module based on the selected operation mode, and performing a data communication with a parent device of the end device using the controlled reception module.

The selecting may include selecting either the operation mode of the first end device or the operation mode of the second end device based on the profile or the selection input of the user when an access to another wireless communication network instead of a currently accessed wireless communication network is sensed in the wireless local area communication system.

### EFFECT

According to embodiments of the present invention, it is possible to satisfy various requirements of an application service by separately providing an end device supporting a sleep mode and an end device not supporting the sleep mode in a wireless local area network.

Also, according to embodiments of the present invention, a parent device of an end device not supporting a sleep mode may transfer data to the end device without waiting for a polling operation of the end device. Accordingly, the parent device may more stably and quickly perform a data communication operation via the end device not supporting the sleep mode.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating devices provided in a wireless local area communication system according to an embodiment of the present invention;

FIG. 2 is a diagram illustrating device types provided in a wireless local area communication system according to an embodiment of the present invention;

FIG. 3 is a diagram illustrating a process of transmitting and receiving data between a router and a personal area network (PAN) coordinator according to an embodiment of the present invention;

FIG. 4 is a diagram illustrating a process of transmitting and receiving data between a first end device and a PAN coordinator according to an embodiment of the present invention;

FIG. 5 is a diagram to describe a delay occurring due to a sleep mode of a first end device according to an embodiment of the present invention; and

FIG. 6 is a diagram illustrating a communication operation between a second end device and a PAN coordinator according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

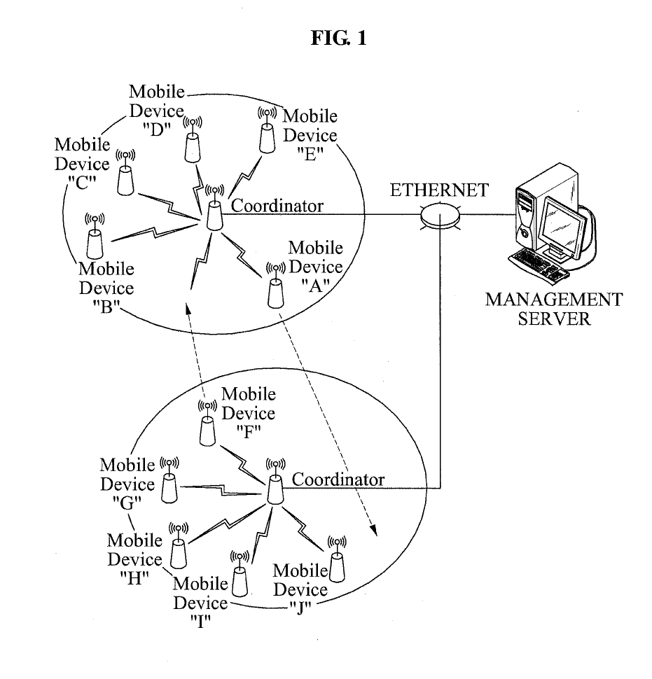

FIG. 1 is a diagram illustrating devices provided in a wireless local area communication system according to an embodiment of the present invention.

Referring to FIG. 1, a single personal area network (PAN) coordinator may generate a communicable wireless communication network in a single coverage area, and a plurality of mobile devices may access the generated wireless communication network.

In this example, the wireless communication network may correspond to a communication network according to a ZigBee standard and an Institute of Electrical and Electronics Engineers (IEEE) 802.15.4 standard. While accessing the wireless communication network generated by the single PAN coordinator, the mobile devices may migrate to and access another network generated by another PAN coordinator. In this case, there is a need to determine as which device each of the mobile devices is to set in the other network.

The ZigBee standard may provide devices that are classified as a PAN coordinator, a router, and an end device. Also, the IEEE 802.15.4 standard may provide devices that are classified as a full function device (FFD) and a reduced function device (RFD). Here, the FFD of the IEEE 802.15.4 standard may correspond to the PAN coordinator and the router of the ZigBee standard, and the RFD of the IEEE 802.15.4 standard may correspond to the end device of the ZigBee standard.

When the wireless local area network is configured as a star topology as shown in FIG. 1, a mobile device moving to the other network may be set as the end device. In particular, in the present embodiment, such end devices may be classified as a first end device and a second end device and thereby be provided.

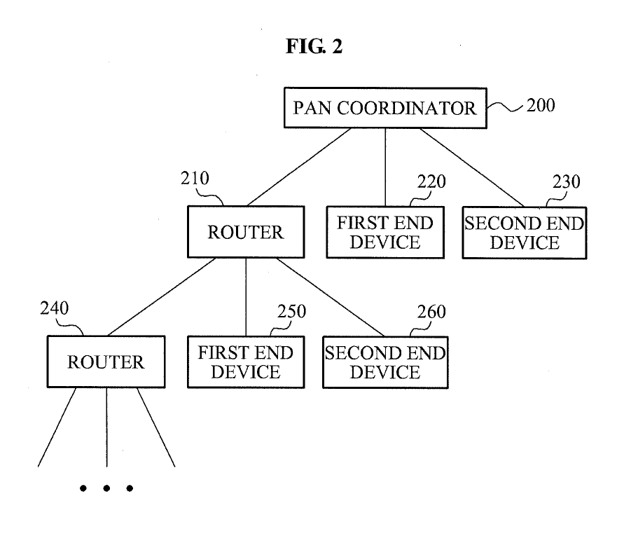

FIG. 2 is a diagram illustrating device types provided in a wireless local area communication system according to an embodiment of the present invention.

Referring to FIG. 2, a PAN coordinator 200 may generate a single network, and may have, as a child device, at least one of a router 210, a first end device 220, and a second end device 230. The router 210 may have, as a child device, at least one of another router 240, another first end device 250, and another second end device 260.

In a conventional ZigBee wireless communication network, three device types, for example, a PAN coordinator, a router, and an end device, may be provided. In a wireless local area communication network according to an embodiment of the present invention, the PAN coordinator 200, the router 210, the first end device 220, for example, a sleep end device, performing a sleep mode, and the second end device 230, for example, a full end device, not performing the sleep mode, may be provided.

The PAN coordinator 200 and the router 210 may be configured to be the same as the PAN coordinator and the router that are provided in the conventional ZigBee wireless communication network.

According to an embodiment of the present invention, a first end device may periodically switch on or off a reception module for a data communication by performing a sleep mode. For example, the first end device may enter into the sleep mode and may maintain the reception module to be in an off-state and then switch the off-state of the reception module to an on-state through a periodical polling operation. When the reception module is in the on-state, the first end device may receive data from a parent device of the first end device,

Even though a second end device may perform functionality similar to the first end device, the second end device may maintain the on-state of the reception module without performing the sleep mode. Since the reception module is maintained to be in the on-state at all times, the first end device may receive data from the parent device of the first end device in real time.

Comparing the second end device with the router, the second end device may transmit and receive data to and from a parent device of the second end device in real time, which is the same as the router. However, due to a characteristic of an end device, the second end device may not have a child device of the second end device and may not transmit a beacon message in response to a beacon request.

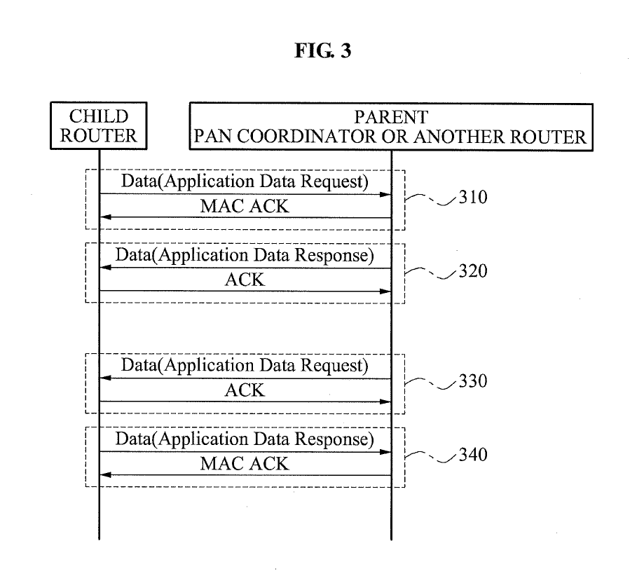

FIG. 3 is a diagram illustrating a process of transmitting and receiving data between a router 210 and a PAN coordinator according to an embodiment of the present invention. Here, the PAN coordinator, for example, the PAN coordinator 200 of FIG. 2 may correspond to a parent device of the router, for example, the router 210 of FIG. 2, and the router may correspond to a child device of the PAN coordinator. In addition to the PAN coordinator, a router of another upper node may correspond to the parent device of the router.

Referring to FIG. 3, operations 310 and 320 correspond to a process of transmitting data from the PAN coordinator to the router. Operations 330 and 340 correspond to a process of transmitting data from the router to the PAN coordinator.

In operation 310, the router may transmit a data message, for example, an application data request message, to the PAN coordinator, and may receive a response message, for example, MAC acknowledgement (ACK) from the PAN coordinator.

In operation 320, the PAN coordinator may transmit a data message, for example, an application data response message including data to be transmitted to the router. In response thereto, the PAN coordinator may receive a response message, for example, ACK from the router.

In operation 330, the PAN coordinator may transmit a data message, for example, an application data request message to the router and in response thereto, may receive a response message, for example, ACK from the router. In operation 340, the router may transmit a data message, for example, an application data response message including data to be transmitted to the PAN coordinator, and may receive a response message, for example, MAC ACK from the PAN coordinator.

As described above, a delay may not occur in the router during the process of receiving, by the router, data from the parent device of the router, and during the process of transmitting, by the router, data to the parent device.

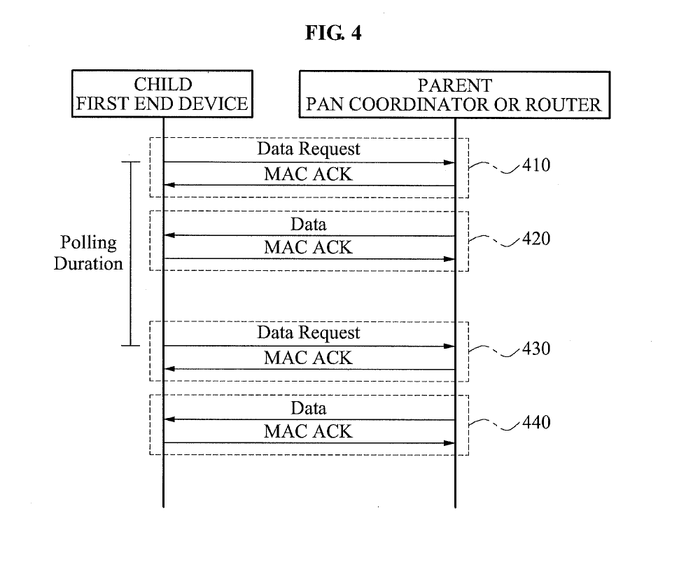

FIG. 4 is a diagram illustrating a process of transmitting and receiving data between a first end device and a parent device of the first end device according to an embodiment of the present invention. Here, the parent device of the first end device, for example, the first end device 220 of FIG. 2 may be a PAN coordinator or a router. The first parent device may correspond to a child device of the parent device.

Referring to FIG. 4, in operation 410, the first end device may switch on a reception module of the first end device by performing a periodical polling operation. The first end device may transmit a data request message to the PAN coordinator and may receive a response message, for example, MAC ACK from the PAN coordinator.

In operation 420, the PAN coordinator may transmit, to the first end device, a data message including data to be transmitted to the first end device, and may receive a response message, for example, MAC ACK from the first end device. In this instance, the first end device may enter into a sleep mode and switch an on-state of the reception module to an off-state.

The first end device may wait for a polling duration of the initiated polling and may switch on the reception module in operation 430. The first end device may transmit a data request message to the PAN coordinator, and may receive a response message, for example, MAC ACK from the PAN coordinator.

When the first end device has data to be transmitted to the PAN coordinator, the first end device may transmit, to the PAN coordinator, a data message including the data to be transmitted, and may receive a response message from the PAN coordinator in operation 440.

As described above, the first end device may transmit and receive data to and from the parent device of the first end device by periodically switching on or off the reception module. When the first end device has data to be transmitted to the parent device of the first end device, the first end device may immediately transmit the corresponding data to the parent device by performing a polling operation. When data is to be received from the parent device, a delay corresponding to a polling duration of the polling may occur.

In particular, a general application service may generally use a protocol of a structure in which an application layer transmits a data transmission request message and receives a response message thereto. Accordingly, a delay may frequently occur in data communication between end devices and parent devices.

In an idle state such as Rx On When Idle=FALSE for power management, the first end device may operate in the sleep mode. Accordingly, to obtain data received from the parent device, the first end device may periodically release the sleep mode through a periodical polling operation and may switch the reception module to be in an on-state.

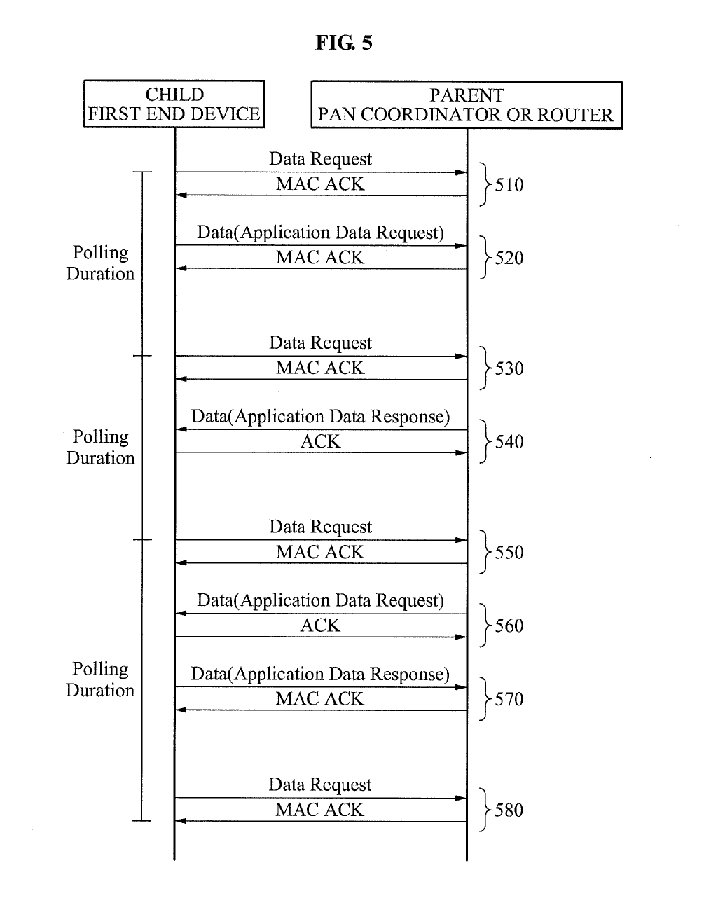

The delay that may occur due to the sleep mode of the first end device will be described with reference to FIG. 5.

Referring to FIG. 5, in operation 510, a first end device may switch on a reception module of the first end device by performing a periodical polling operation. The first end device may transmit a data request message to a PAN coordinator and then receive a response message, for example, MAC ACK from the PAN coordinator.

In operation 520, to request the PAN coordinator for data transmission, the first end device may transmit a data message, for example, an application data request message to the PAN coordinator and receive a response message, for example, MAC ACK from the PAN coordinator.

In this case, in response to the data message, for example, the application data request message, the PAN coordinator may need to transmit a data message, for example, an application data response message to the first end device. However, since a reception module of the first end device is in an off-state, the PAN coordinator may not immediately transmit the data message, for example, the application data response message to the first end device.

The first end device may wait for a polling duration of the polling and then retransmit the data request message to the PAN coordinator in operation 530. The first end device may receive a response message, for example, MAC ACK from the PAN coordinator.

In operation 540, the PAN coordinator may transmit the data message, for example, the application data response message to the first end device and may receive a response message, for example, ACK from the first end device.

When the first end device desires to request the parent device of the first end device for data transmission and thereby to receive data from the parent device, a delay may occur due to polling of the first end device.

When the PAN coordinator requests the first end device for data transmission, the following operations 550 through 570 may be performed.

In operation 550, the first end device may wait for a polling duration of the polling and transmit a data request message to the PAN coordinator and receive a response message, for example, MAC ACK from the PAN coordinator.

In operation 560, the PAN coordinator may transmit, to the first end device, a data message, for example, an application data request message requesting the first end device for data transmission. The PAN coordinator may receive a response message, for example, ACK from the first end device.

In operation 570, the first end device may transmit a data message, for example, an application data response message to the PAN coordinator and receive a response message, for example, MAC ACK from the PAN coordinator.

In operation 580, the first end device may perform a periodical polling operation and may retransmit the data request message to the PAN coordinator.

As described above, when the PAN coordinator is to receive data from the first end device, the PAN coordinator may wait for a polling operation of the first end device and a data request message and then request the first end device for data transmission.

However, some application services may put rapid data communication and stable network formation before data transmission. Therefore, according to an embodiment of the present invention, a second end device in which the above delay process is enhanced may be separately further provided.

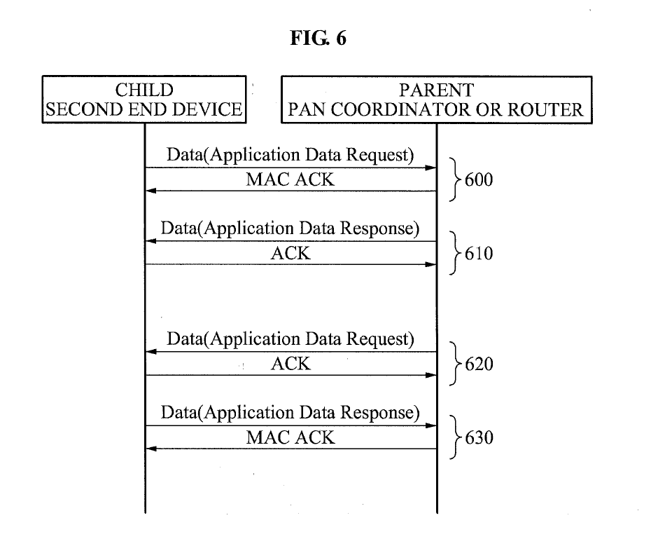

FIG. 6 is a diagram illustrating a communication operation between a second end device and a PAN coordinator according to an embodiment of the present invention. Here, the PAN coordinator, for example, the PAN coordinator 200 of FIG. 2 may correspond to a parent device of the second end device, for example, the second end device 230 and the second end device 230 may correspond to a child device of the PAN coordinator 200. As in the other second end device 260, a router of an upper node may be the parent device.

The second end device may maintain an on-state of a reception module without performing a sleep mode of a first end device. In operation 600, the second end device may transmit a data message, for example, an application data request message to the PAN coordinator without performing a polling operation and may receive a response message, for example, MAC ACK from the PAN coordinator.

In operation 610, the PAN coordinator may transmit a data message including a data message, for example, an application data response message including data to be transmitted to the first end device and then, may receive a response message, for example, ACK from the PAN coordinator.

Similarly, in operation 620, the PAN coordinator may transmit a data message, for example, an application data request message to the second end device and thereby request the second end device for data transmission and may receive a response message, for example, MAC ACK from the second end device.

In operation 630, the second end device may transmit, to the PAN coordinator, a data message, for example, an application data response message including data to be transmitted to the PAN coordinator and may receive a response message, for example, ACK from the PAN coordinator.

As described above, during a process in which the second end device requests the parent device of the second end device for data transmission and thereby receives data from the parent device, and a process in which the parent device of the second end device requests the second end device for data transmission and thereby receives data, a delay according to the sleep mode of the second end device and the polling duration may not occur.

According to an embodiment of the present invention, a wireless local area communication system may separately provide a first end device to periodically switch on or off a reception module for a data communication by performing a sleep mode, and a second end device to maintain an on-state of the reception module without performing the sleep mode. Therefore, it is possible to selectively employ a power saving corresponding to an advantage of the first end device and a rapid data communication corresponding to an advantage of the second end device.

When a mobile terminal enters a coverage area of another PAN coordinator, the mobile terminal may select one of the first end device and the second end device, and may operate as the selected device.

For example, the mobile terminal may determine a device to operate between the first end device and the second end device based on a profile or a selection input of a user.

The above-described exemplary embodiments of the present invention may be recorded in computer-readable media including program instructions to implement various operations embodied by a computer. The media may also include, alone or in combination with the program instructions, data files, data structures, and the like. Examples of program instructions include both machine code, such as produced by a compiler, and files containing higher level code that may be executed by the computer using an interpreter.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A wireless local area communication system, comprising:
a personal area network (PAN) coordinator to generate a single wireless communication network, having a PAN identifier (ID), in a single coverage area;
a router to perform a routing function associated with the PAN coordinator in interoperation with the PAN coordinator; and
at least one end device to perform a data communication with the PAN coordinator or the router when the at least one end device enters the coverage area,
wherein the at least one end device is classified as a first end device to periodically switch on or off a reception module for the data communication by performing a sleep mode, and as a second end device to maintain an on-state of the reception module without performing the sleep mode.

2. The wireless local area communication system of claim 1, wherein when the at least one end device enters the coverage area, the at least one end device operates as one of the first end device and the second end device based on a profile or a selection input of a user.

3. The wireless local area communication system of claim 1, wherein the wireless local area communication system provides a wireless communication according to a ZigBee communication standard or an Institute of Electrical and Electronics Engineers (IEEE) communication standard.

4. An operation method of an end device in a wireless local area communication system, the method comprising:
selecting one operation mode from an operation mode of a first end device and an operation mode of a second end device, the first end device periodically switching on or off a reception module for a data communication by performing a sleep mode based on a profile or a selection input of a user, and the second end device maintaining an on-state of the reception module without performing the sleep mode; and
controlling the reception module based on the selected operation mode, and performing a data communication with a parent device of the end device using the controlled reception module.

5. The method of claim 4, wherein the selecting comprises selecting either the operation mode of the first end device or the operation mode of the second end device based on the profile or the selection input of the user when an access to another wireless communication network instead of a currently accessed wireless communication network is sensed in the wireless local area communication system.
